(19) United States
(12) Patent Application Publication
(10) Pub. No.: US 2008/0280604 A1
(43) Pub. Date: Nov. 13, 2008

(54) Forbidden neighbor cell list

(75) Inventors: Ivan Ore, Nummela (FI); Lars Dalsgaard, Oulu (FI); Jarkko T. Koskela, Oulu (FI); Sari Nielsen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/003,652

(22) Filed: Dec. 28, 2007

Related U.S. Application Data
(60) Provisional application No. 60/877,619, filed on Dec. 29, 2006.

(51) Int. Cl. H04Q 7/34; H04Q 7/22

(52) U.S. Cl. 455/424; 455/422.1

(57) ABSTRACT

Mobility in E-UTRAN might not rely on neighbor cell list. In such a case, the user equipment (UE) may be responsible for finding cells and reporting to the network. Consequently signaling load may be increased and also handover (HO) performance can be degraded for the cases in which the target cell proposed by the UE is not good. Certain embodiments of the present invention give the operator some control of the signaling load and HO performance by providing a list of forbidden cells with regard to which the UE does not have to search and report.

### CROSS REFERENCE TO RELATED APPLICATION

This application is related to, claims the priority of, and incorporates by reference in its entirety U.S. Provisional Patent Application No. 60/877,619 filed Dec. 29, 2006.

### BACKGROUND OF THE INVENTION

1. Field of the Invention

Certain embodiments of the present invention may have applicability to communication networks and particularly wireless communication networks. More specifically, certain embodiments of the present invention may relate to Universal Mobile Telecommunications System (UMTS) Terrestrial Radio Access Network (UTRAN) Long Term Evolution (LTE) and Evolved UTRAN (E-UTRAN).

Mobility in E-UTRAN might not rely on neighbor cell list. In such a case, the user equipment (UE) may be responsible for finding cells and reporting to the network. Consequently signaling load may be increased and also handover (HO) performance can be degraded for the cases in which the target cell proposed by the UE is not good. Certain embodiments of the present invention give the operator some control of the signaling load and HO performance by providing a list of forbidden cells with regard to which the UE does not have to search and report.

2. Description of the Related Art

In Global System for Mobile communication (GSM) Enhanced Data rates for Global Evolution (EDGE) Radio Access Network (GERAN) and UTRAN, the operator has the control of a neighbor cell list. Thus, if a target cell is not performing well, the operator can take this neighbor cell out of the neighbor cell list. By doing so, the UE will not report the bad neighbor cell anymore. In addition, filtering mechanisms can be applied so that only the neighbor cells with the strongest radio conditions are reported by the UE. However, filtering cannot address all of the potential problems related to handover performance.

In some second generation (2G) and third generation (3G) inter-working networks the neighbor cell list is optimized (or generated) in order to provide good service for the normal user/customer. It may be part of the network policy to have some users (e.g. roaming) using different rules than the general. In a very specific example the operator might want to limit some users' access to certain cells or other RAN. The state of the art, however, does not provide any good solutions for limiting access of groups of users to some cells.

### SUMMARY OF THE INVENTION

The present invention provides, in one embodiment, an apparatus. The apparatus can include a processor configured to process a forbidden neighbor cell list. The apparatus can also include a receiver configured to perform measurements based on the forbidden neighbor cell list.

Another embodiment of the present invention is also an apparatus. The apparatus can include processor means for processing a forbidden neighbor cell list. The apparatus can also include receiver means for performing measurements based on the forbidden neighbor cell list.

A further embodiment of the present invention can also be an apparatus. The apparatus can include a memory configured to store a forbidden neighbor cell list. The apparatus can further include a transmitter configured to communicate the forbidden cell list to a user equipment.

Another embodiment of the present invention can also be an apparatus. The apparatus can include storage means for storing a forbidden neighbor cell list. The apparatus can also include transmission means for communicating the forbidden cell list to a user equipment.

The present invention can also provide, in one embodiment a method. The method can include providing a forbidden neighbor cell list. The method can also include performing measurements based on the forbidden neighbor cell list.

Another embodiment of the present invention can be a system. The system can include a user equipment, including a processor configured to process a forbidden neighbor cell list and a receiver configured to perform measurements based on the forbidden neighbor cell list. The system can also include a network node, including a transmitter configured to communicate the forbidden cell list to the user equipment.

A further embodiment of the present invention can be a computer program product embodied on a computer-readable medium, encoding instructions for performing a method. The method can include processing a forbidden neighbor cell list. The method can also include performing measurements based on the forbidden neighbor cell list.

### BRIEF DESCRIPTION OF THE DRAWINGS

For proper understanding of the invention, reference should be made to the accompanying drawings.

FIG. 1 illustrates a network system in which an embodiment of the present invention can be implemented.

FIG. 2 illustrates a flow diagram of a method according to an embodiment of the present invention.

FIG. 3 illustrates an embodiment of the invention that is a computer program product embodied on a computer-readable medium, encoding instructions for performing a method.

FIG. 4 illustrates a network in which an embodiment of the present invention can be implemented.

### DETAILED DESCRIPTION OF THE PREFERRED EMBODIMENT(S)

In typical cellular networks, a UE can monitor surrounding cells that belong to a list provided by the network. This list is referred to as a “Neighbor cell list” (NCL). The neighbor cell list can be broadcasted via System Information (SI) and the UE can use this list to measure cells during idle mode and dedicated mode. The neighbor cell list can be created by the operator based on radio network planning.

In third generation partnership project (3GPP) release 6, it is possible that the UE can monitor other cells not included in the neighbor cell list. However, the neighbor cell list can still be used.

Mobility in E-UTRAN might not rely on the neighbor cell list. In such a case, the UE can be responsible for finding cells and reporting to the network. Consequently the signaling load can increase and also the handover (HO) performance can be degraded for the cases in which the target cell proposed by the UE is not good.

Certain embodiments of the present invention, therefore, give the operator some control on the signaling load and HO performance by providing a list of forbidden cells for which the UE does not have to search and/or report. Thus, in certain embodiments, based on the received forbidden list from an evolved Node B (eNB), the UE would omit further measurements on the cells included in the forbidden list.

Not using a neighbor cell list in E-UTRAN may provide the benefit of reduced SI load and reduced radio network planning efforts. However, there may be trade-offs to such an approach, including handover (HO) performance degradation, unnecessary signaling increase, increased UE load and complexity, network boundary issues, and country boundary issues.

HO performance degradation may be characterized in that not all the neighbor cells reported by UE will be good target cells for handovers. Unsuccessful handovers may be due to high load in a target cell, high levels of interference, hardware (HW) problems, and the like. Certain conditions can be checked by the source cell before handover (e.g. verifying the load in the target cell). Not all the conditions, however, can be verified. For example, HW problems in the target cell cannot easily be verified.

Unnecessary signaling increase in the air interface may be characterized in that even if certain neighbor cells are bad neighbors from the handover performance point of view, the UE can continue reporting those cells to the network. Thus, signaling load can increase unnecessarily.

Increased UE load and complexity can be characterized in that, if the UE does not have any prior neighbor cell information, there can be situations in which the UE can either extraneously report a cell from a non-serving Public Land Mobile Network (PLMN) or, in order to prevent this, further identify the cells. The consequence of this dilemma can be that the measurement report might be loaded with cells outside the serving PLMN (which may result in reduced mobility performance) or the UE may have to further identify found cells (which may result in increased UE load and complexity).

In certain cases, it can be desirable to restrict the UE to measure certain cells. For example, operators sharing the network may decide which cells should not be reported by UEs. Near country borders, for example, it may also be desirable that the UE not measure and report cells from other operators in the neighboring country. This can pose challenges if an NCL is not used.

Furthermore, in scenarios such as country borders, the UE may not be able to distinguish between cells from different operators. In such cases there may be unnecessary reporting of cells.

Accordingly, in certain embodiments of the present invention, the operator is given some control of the signaling load and HO performance through control of a list of forbidden cells about which the UE does not have to search and report.

The HO performance degradation, unnecessary increase of the signaling load and increased UE complexity and load can be avoided, ameliorated, or reduced by use of a forbidden neighbor cell list (F-NCL). The F-NCL can be an operator configurable list in which the operator can group all (or some portion of) the bad neighbor cells.

The bad neighbor cells can be those cells about which the operator does not want the UE to measure, search, or report. There is no absolute requirement that the bad neighbor cells have bad equipment or other negative characteristics—they may be simply undesirable in the view of the operator because they are, for example, in another country or operated by another operator. Thus, the characterization of what is a bad neighbor cell may be defined by the operator's requirements.

By making the UE aware of the F-NCL, the operator can ensure that the UE will not attempt to measure and report those cells to the network. In addition, the operator can ensure that the UE will not use the neighbors on the F-NCL for reselection mobility when in RRC_IDLE.

The F-NCL can be implemented as a table stored in an enhanced Node B (eNodeB) or other node having base station functionality. The F-NCL can include a list of neighbor cells that should not be measured by the UE. In addition, if common or default parameters for idle and dedicated mode operation are used, the F-NCL can be used to include a list of exceptional configurations. For example, the F-NCL can identify neighbor cells with special parameters to be considered in idle/dedicated mode.

The F-NCL can be defined by the operator and can be transmitted via the SI or in dedicated mode. Even if the F-NCL is sent via SI, the added SI load may not be as high as the traditional NCL. Another implementation can be to send the NCL list in dedicated mode via Radio Resource Control (RRC) signaling.

An F-NCL can be used for intra-frequency/inter-frequency and inter-Radio Access Technology (RAT) measurements. Furthermore, an F-NCL can be implemented as a list of cells collected and maintained by a UE based on well defined rules in 3GPP.

Thus, particularly when, for example, an NCL is not used, an F-NCL can be used as a way to provide the network operator with some capability to control the signaling load and target cells for handovers. Thus, HO performance degradation, unnecessary increase of the signaling load, and increased UE complexity and load that may occur without an NCL can be avoided by use of forbidden neighbor cell list (F-NCL).

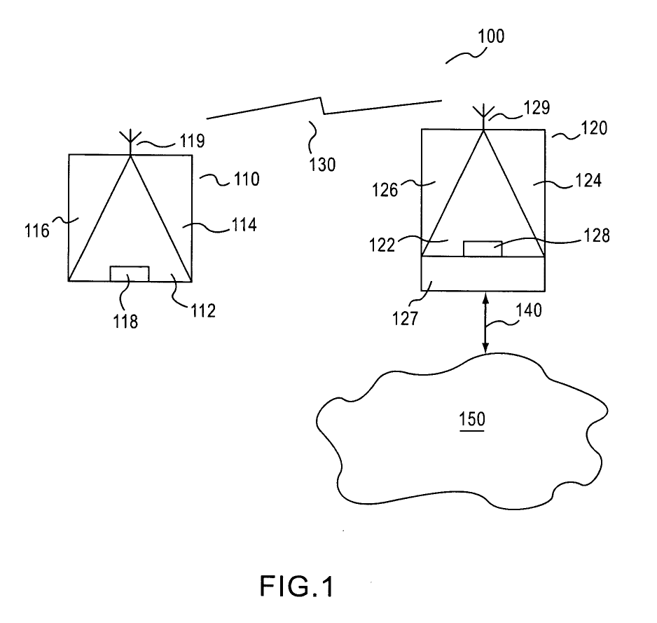

FIG. 1 illustrates a network in which an embodiment of the present invention can be implemented. As shown in FIG. 1, the network 100 can include a user equipment 110 including a processor 112 configured to process a forbidden neighbor cell list. The user equipment 110 can also include a receiver 114 configured to perform measurements based on the forbidden neighbor cell list. Additionally, the user equipment 110 can include a transmitter 116 that can work together with the receiver 114 to engage in communication tasks. The user equipment 110 can also include a memory 118 for storing information.

The receiver 114 can be configured not to perform measuring regarding cells that are identified by the forbidden neighbor cell list. The processor 112 can be configured to identify as bad neighbor cells those cells that correspond to the forbidden neighbor cell list. The processor 112 can be configured to avoid reporting regarding cells that are identified by the forbidden neighbor cell list.

The processor 112 can be configured to compare a known cell to a table of cells in the forbidden neighbor cell list. The processor 114 can be configured to compare a known cell to a rule in the forbidden neighbor cell list. The forbidden neighbor cell list can be configured to identify a group of all bad neighbor cells, as defined by an operator of the network 100 to which the user equipment is connected.

The user equipment can be, for example, a mobile node, a mobile station, a mobile terminal, or a cell phone. The user equipment can also be, for example, a personal digital assistant (PDA) or any other portable communications-enabled electronic device.

The memory 118 can store configuration information for the user equipment 110 as well as other information. For example, the memory 118 can be configured to store the forbidden neighbor cell list.

The network 100 can also include a network node 120. The network node 120 can include a memory 128 configured to store a forbidden neighbor cell list. The network node 120 can also include a transmitter 126 configured to communicate the forbidden cell list to the user equipment 110 over a wireless link 130. The network node 120 can also include a receiver 124 that is configured to coordinate with the transmitter 126 and a processor 122, to perform communication tasks.

The memory 128 can be configured to store the forbidden neighbor cell list as a table. The memory 128 can also or alternatively be configured to store the forbidden neighbor cell list as a list of exceptional configurations. The memory 128 can also or additionally be configured to store the forbidden neighbor cell list as a list of bad neighbor cells.

The forbidden neighbor cell list can include those cells that have hardware problems. The forbidden neighbor cell list can also include those cells that are in a different country than the user equipment. The forbidden neighbor cell list can additionally includes those cells outside a serving public land mobile network. The forbidden neighbor cell list can also include those cells to which handover or cell reselection should not be made. The forbidden neighbor cell list can further include those cells that belong to an operator that is different from an operator corresponding to the user equipment. The forbidden neighbor cell list can also be used to deliver neighbor cell specific configuration to the user equipment. The forbidden neighbor cell list can also include user specific (such as, for example, International Mobile Subscriber Identity (IMSI)) or subscription specific information so that it can be possible that different user equipments can have different respective forbidden neighbor cell lists.

The transmitter 126 can be configured to communicate the forbidden cell list to the user equipment 110.

The network node 120 can be an enhanced Node B, a base station, an access gateway, an access point, or a relay node. The network node 120 can be any network node with base station functionality.

The network node 120 can include an antenna 129, which can be configured for wireless communication. Likewise, the user equipment 110 can include an antenna 119, which can be configured for wireless communication with the network node 120 over wireless communication link 130.

The network node 120 can also include a network interface 127 for communicating with a core network 150, such as an Evolved Packet Core (EPC) network. The communication with the core network 150 may occur over a network communication link 140.

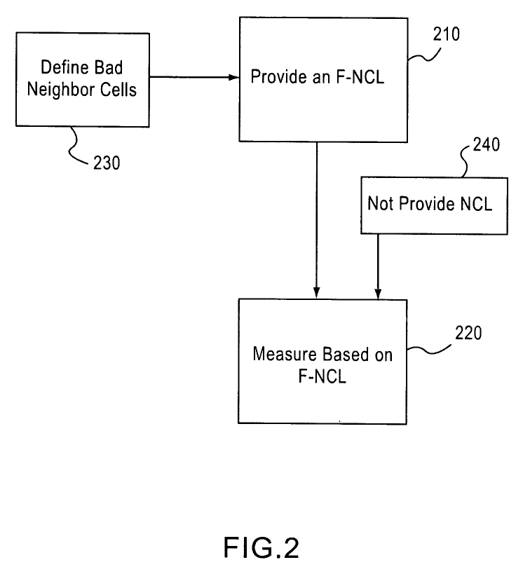

FIG. 2 illustrates a flow diagram of a method according to an embodiment of the present invention. As shown in FIG. 2, a method can include providing 210 a forbidden neighbor cell list. The method can also include performing 220 measurements based on the forbidden neighbor cell list.

The providing 210 can include grouping bad neighbor cells into the forbidden neighbor cell list. The grouping can include providing rules for identifying bad neighbor cells. The grouping can also or alternatively include providing an identification of bad neighbor cells.

The method can also include defining 230 bad neighbor cells as including those cells that have hardware problems. The method can also or alternatively include defining 230 bad neighbor cells as including those cells that are in a different country than the user equipment. The method can also or alternatively include defining 230 bad neighbor cells as including those cells outside a serving public land mobile network.

The method can also or alternatively include defining 230 bad neighbor cells as including those cells to which handover or cell reselection should not be made. The method can also or alternatively include defining 230 bad neighbor cells as including those cells that belong to an operator that is different from an operator corresponding to the user equipment.

The providing 210 can include providing a table stored in an enhanced Node B. The defining 230 can include configuring the forbidden neighbor cell list to include a list of exceptional configurations. The providing 210 can include transmitting the forbidden neighbor cell list by system information or in dedicated mode. The providing 210 can alternatively include receiving the forbidden neighbor cell list by system information or in dedicated mode.

The providing 210 can include defining 230 the forbidden neighbor list by an operator (the location of the providing 210 can be at an eNodeB and can be updated by the operator according to e.g network statistics). Another approach can be to let the UE build the forbidden neighbor cell list based on some network specific rules such as power level and/or quality thresholds. The method can further include not providing 240 a neighbor cell list.

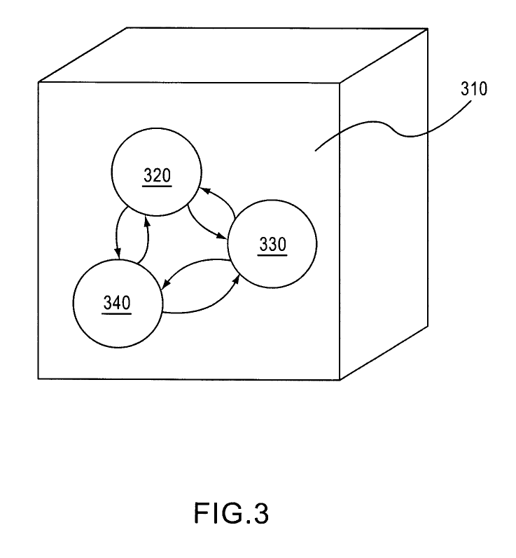

FIG. 3 illustrates an embodiment of the invention that is a computer program product embodied on a computer-readable medium, encoding instructions for performing a method. The computer program product can be embodied on a computer readable medium 310. The computer program product can include encoded instructions for processing 320 a forbidden neighbor cell list 330, which may also be stored on the computer readable medium 310. The computer program product can include encoded instructions for performing 340 measurements based on the forbidden neighbor cell list 330.

As shown in FIG. 3 the computer program product can be implemented in hardware, software, or a hybrid implementation. The computer program product can be composed of modules that are in operative communication with one another, and which are designed to pass information or instructions to a communications device such as a user equipment or network node. The computer program product can be configured to operate on a general purpose computer or an application specific integrated circuit (ASIC).

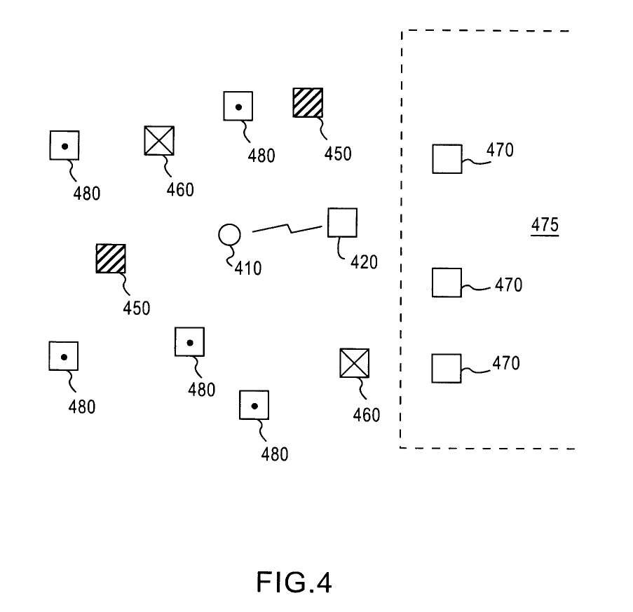

FIG. 4 illustrates a network in which an embodiment of the present invention can be implemented. As shown in FIG. 4, there can be a user equipment 410 in radio communication with a network node 420. There may also be other network nodes in the area.

There may be damaged network nodes 450, that have hardware problems. The network node 420 or the user equipment 410 may identify these damaged network nodes 450 as being unsuitable for handover, and may add them to a forbidden neighbor cell list.

Similarly, there may be competitor network nodes 460 that are operated by another operator than the operator operating network node 420. The network node 420 or the user equipment 410 may identify these competitor network nodes 460 as being unsuitable (or not preferred or disfavored) for handover, and may add them to a forbidden neighbor cell list.

Likewise, there may be foreign network nodes 470 that are operated in another country 475 than the country in which the network node 420 is located. The network node 420 or the user equipment 410 may identify these competitor network nodes 460 as being unsuitable for handover, and may add them to a forbidden neighbor cell list.

The remainder of the network nodes 480 may be subject to measuring and reporting by the user equipment 410. Thus, if there were a neighbor cell list, remaining network nodes 480 would be on such a list. However, such a list may not be necessary if a forbidden neighbor cell list is used.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A method, comprising:
providing a forbidden neighbor cell list; and
performing measurements based on the forbidden neighbor cell list.

2. The method of claim 1, wherein the providing comprises grouping bad neighbor cells into the forbidden neighbor cell list.

3. The method of claim 2, wherein the grouping comprises providing rules for identifying bad neighbor cells.

4. The method of claim 3, wherein the grouping can include providing an identification of bad neighbor cells.

5. The method of claim 1, further comprising:
defining bad neighbor cells as including those cells that have hardware problems.

6. The method of claim 1, further comprising:
defining bad neighbor cells as including those cells that are in a different country than the user equipment.

7. The method of claim 1, further comprising:
defining bad neighbor cells as including cells outside a serving public land mobile network.

8. The method of claim 1, further comprising:
defining bad neighbor cells as cells to which handover or cell reselection should not be made.

9. The method of claim 1, further comprising:
defining bad neighbor cells as cells that belong to an operator that is different from an operator corresponding to the user equipment.

10. The method of claim 1, wherein the providing comprises providing a table stored in an enhanced Node B.

11. The method of claim 1, further comprising:
configuring the forbidden neighbor cell list to include a list of exceptional configurations.

12. The method of claim 1, wherein the providing comprises transmitting the forbidden neighbor cell list by system information or in dedicated mode.

13. The method of claim 1, wherein the providing comprises defining the forbidden neighbor list by an operator.

14. The method of claim 1, further comprising:
abstaining from providing a neighbor cell list.

15. An apparatus, comprising:
a processor configured to process a forbidden neighbor cell list; and
a receiver configured to perform measurements based on the forbidden neighbor cell list.

16. The apparatus of claim 15, wherein the receiver is configured not to perform measuring regarding cells that are identified by the forbidden neighbor cell list.

17. The apparatus of claim 15, wherein the processor is configured to identify as bad neighbor cells those cells that correspond to the forbidden neighbor cell list.

18. The apparatus of claim 15, wherein the processor is configured to avoid reporting regarding cells that are identified by the forbidden neighbor cell list.

19. The apparatus of claim 15, wherein the processor is configured to compare a known cell to a table of cells in the forbidden neighbor cell list.

20. The apparatus of claim 15, wherein the processor is configured to compare a known cell to a rule in the forbidden neighbor cell list.

21. The apparatus of claim 15, wherein the forbidden neighbor cell list is configured to identify a group of all bad neighbor cells, as defined by an operator of a network to which the user equipment is connected.

22. The apparatus of claim 15, wherein the apparatus comprises a user equipment, a mobile node, a mobile station, a mobile terminal, a personal digital assistant, or a cell phone.

23. An apparatus, comprising:
processor means for processing a forbidden neighbor cell list; and
receiver means for performing measurements based on the forbidden neighbor cell list.

24. An apparatus, comprising:
a memory configured to store a forbidden neighbor cell list; and
a transmitter configured to communicate the forbidden cell list to a user equipment.

25. The apparatus of claim 24, wherein the memory is configured to store the forbidden neighbor cell list as a table.

26. The apparatus of claim 24, wherein the memory is configured to store the forbidden neighbor cell list as a list of exceptional configurations.

27. The apparatus of claim 24, wherein the memory is configured to store the forbidden neighbor cell list as a list of bad neighbor cells.

28. The apparatus of claim 24, wherein the forbidden neighbor cell list comprises those cells that have hardware problems.

29. The apparatus of claim 24, wherein the forbidden neighbor cell list comprises those cells that are in a different country than the user equipment.

30. The apparatus of claim 24, wherein the forbidden neighbor cell list comprises those cells outside a serving public land mobile network.

31. The apparatus of claim 24, wherein the forbidden neighbor cell list comprises those cells to which handover or cell reselection should not be made.

32. The apparatus of claim 24, wherein the forbidden neighbor cell list comprises those cells that belong to an operator that is different from an operator corresponding to the user equipment.

33. The apparatus of claim 24, wherein the transmitter is configured to communicate the forbidden cell list to a user equipment.

34. The apparatus of claim 24, wherein the user equipment is a mobile node, a mobile station, a mobile terminal, personal digital assistant, or a cell phone.

35. The apparatus of claim 34, wherein the apparatus comprises a network node, an enhanced Node B, a base station, an access gateway, an access point, or a relay node.

36. An apparatus, comprising:
storage means for storing a forbidden neighbor cell list; and
transmission means for communicating the forbidden cell list to a user equipment.

37. A system, comprising:
a user equipment, comprising a processor configured to process a forbidden neighbor cell list and a receiver configured to perform measurements based on the forbidden neighbor cell list; and
a network node, comprising a transmitter configured to communicate the forbidden cell list to the user equipment.

38. A computer program product embodied on a computer-readable medium, encoding instructions for performing a method, the method comprising:
processing a forbidden neighbor cell list; and
performing measurements based on the forbidden neighbor cell list.
